(19) United States
(12) Patent Application Publication
(10) Pub. No.: US 2003/0043432 A1
(43) Pub. Date: Mar. 6, 2003

(54) Optical transponder

(76) Inventors: Oren Marmur, Kiryat Ono (IL); Joseph Arol, Kityat Ono (IL); Ido Gur, Rishon Lezion (IL); Benny Maly, Moshay Satariya (IL)

Correspondence Address: Harold L. Novick, NATH & ASSOCIATES PLLC, 1030 15th Street, N.W.- 6th Floor, Washington, DC, 20005, US

(21) Appl. No.: 10/271,770

(22) Filed: Oct. 17, 2002

Related U.S. Application Data
(63) Continuation of application No. PCT/IL01/00343, filed on Apr. 15, 2001.

(30) Foreign Application Priority Data
Apr. 18, 2000 (IL) 135715

(51) Int. Cl. H04B 10/00

(52) U.S. Cl. 359/152

(57) ABSTRACT

A dual E/O transmitter module optical transponder comprising an O/E receiver module capable of converting an ingressing optical signal from an optical signal source to an electrical signal, a pair of E/O transmitter modules connected in parallel and each capable of converting said electrical signal to an egressing optical signal, a control device for enabling one of said pair of E/O transmitter modules and disabling the other of said pair of E/O transmitter modules and an optical coupler coupled to said pair of E/O transmitter modules for feeding said egressing optical signal from said enabled E/O transmitter module to an optical signal destination.

### FIELD OF THE INVENTION

The invention is in the field of optical transponders.

### BACKGROUND OF THE INVENTION

Optical ring networks include two optical fibers, one dedicated for adding and dropping working channels and the other dedicated for protection channels. Optical ring networks typically include one or more so called unidirectional optical transponders for adding an optical signal to a working channel or dropping one off therefrom, so called 1X2 add direction optical transponders for adding identical optical signals to the working channel and the protection channel, and so called 2X1 drop direction optical transponders for dropping an optical signal from either the working channel or the protection channel.

### SUMMARY OF THE INVENTION

In accordance with the present invention, there is provided a dual E/O transmitter module optical transponder comprising:

(a) an O/E receiver module capable of converting an ingressing optical signal from an optical signal source to an electrical signal;

(b) a pair of E/O transmitter modules connected in parallel and each capable of converting said electrical signal to an egressing optical signal;

(c) a control device for enabling one of said pair of E/O transmitter modules and disabling the other of said pair of E/O transmitter modules; and

(d) an optical coupler coupled to said pair of E/O transmitter modules for feeding said egressing optical signal from said enabled E/O transmitter module to an optical signal destination.

The present invention presents a novel solution to the problem of cessation of data transmission through a conventional unidirectional or drop direction optical transponder having only a single E/O transmitter module in the event of its equipment failure.

### BRIEF DESCRIPTION OF THE DRAWINGS

In order to understand the invention and to see how it can be carried out in practice, preferred embodiments will now be described, by way of non-limiting examples only, with reference to the accompanying drawings, in which similar parts are likewise numbered, and in which:

FIG. 1 is a schematic representation of a dual E/O transmitter module unidirectional optical transponder; and

FIG. 2 is a schematic representation of a dual E/O transmitter module drop direction optical transponder.

### DETAILED DESCRIPTION OF THE DRAWINGS

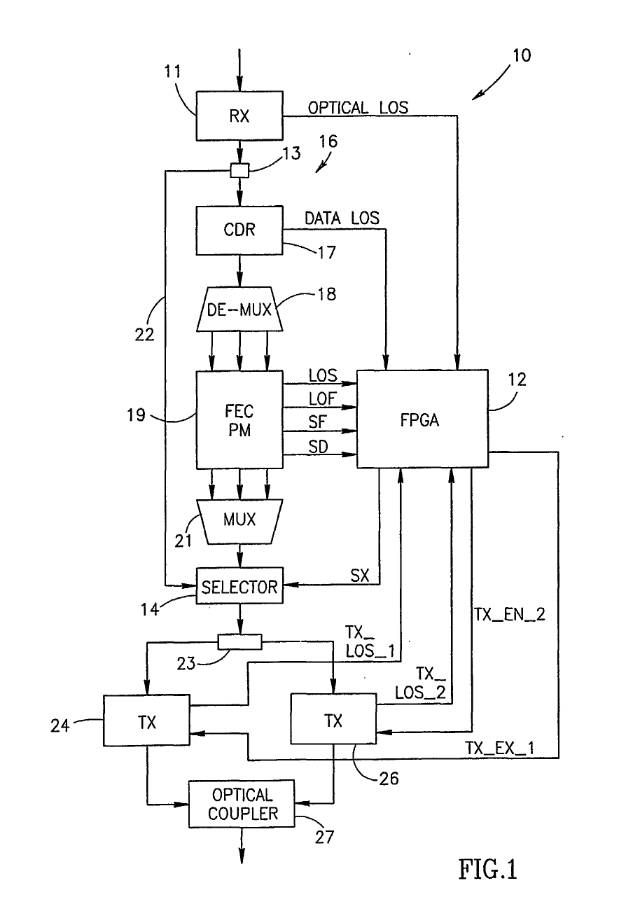

FIG. 1 shows a dual E/O transmitter module unidirectional optical transponder 10 including an optical to electrical (O/E) receiver module 11 coupled to an optical signal source (not shown); a field programmable gate array (FPGA) control device 12; an electrical splitter 13; an electrical selector 14 (constituting a switching element); a main path 16 extending between the splitter 13 and the selector 14 and having a Clock and Data Recovery (CDR) unit 17, a demultiplexer 18, a Forward Error Correction (FEC) and Performance Monitoring (PM) unit 19, and a multiplexer 21; a bypass path 22 (constituted by an electrical shunt) extending between the splitter 13 and the selector 14; a second electrical splitter 23; a pair of E/O transmitter modules 24 and 26 connected in parallel, and an optical coupler 27 coupled to an optical signal destination (not shown).

The O/E receiver module 11 converts an ingressing optical signal to an electrical signal, and provides an optical Loss of Signal (LOS) signal to the FPGA control device 12 in the event that no optical signal is detected thereat. The splitter 13 splits an electrical signal from the O/E receiver module 11 into two identical signals which are respectively fed to the main path 16 and the bypass path 22. The CDR unit 17 performs clock and data recovery on an electrical signal, and provides a data Loss of Signal (LOS) signal to the FPGA control unit 11 in the event that no data signal i.e. a stream of consecutive zeros is detected thereat. The FEC and PM unit 19 performs forward error correction and performance monitoring on an electrical signal, and provides a data Loss of Signal (LOS) signal, a Loss of Frame (LOF) signal, a Signal Fail (SF) signal, and a Signal Degrade (SD) signal to the FPGA control device 12 as appropriate. The selector 14 can feed either an electrical signal from one of the main path 16 or the bypass path 22 to the splitter 23 as determined by an SX signal from the FPGA control device 12. The splitter 23 splits the electrical signal to two identical signals which are respectively fed to the E/O transmitter modules 24 and 26. The E/O transmitter modules 24 and 26 are capable of being independently enabled by an TX_EN signal from the FPGA control device 12 and can each convert an electrical signal to an egressing optical signal which is fed to the optical coupler 27. The E/O transmitter modules 24 and 26 provide TX_LOS signals to the FPGA control device 12 in the event that they are enabled but no optical signal is detected thereat.

In the default mode of operation of the optical transponder 10, the FPGA control unit 12 switches the selector 23 to feed electrical signals from the main path 16 to the E/O transmitter module 24, and disables the E/O transmitter module 26. In the case of an TX_LOS_{—}1 signal from the E/O transmitter module 24, it is disabled and the E/O transmitter module 26 is enabled. The protection against equipment failure of the E/O transmitter module 24 by the E/O transmitter module 26 is unaffected by the position selection of the selector 23.

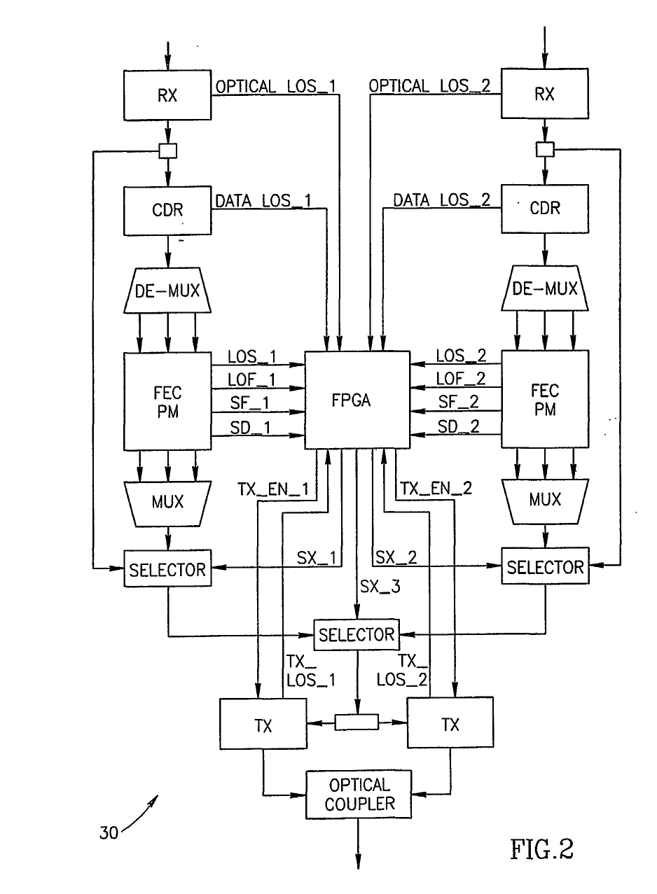

While the invention has been described with respect to a limited number of embodiments, it will be appreciated that many variations, modifications, and other applications of the invention can be made within the scope of the appended claims. For example, the dual E/O transmitter module optical transponder is particularly suitable for implementation as a drop direction optical transponder 30 (see FIG. 2).

1. A dual E/O transmitter module optical transponder comprising:
(a) an O/E receiver module capable of converting an ingressing optical signal from an optical signal source to an electrical signal;
(b) a pair of E/O transmitter modules connected in parallel and each capable of converting said electrical signal to an egressing optical signal;
(c) a control device for enabling one of said pair of E/O transmitter modules and disabling the other of said pair of E/O transmitter modules; and
(d) an optical coupler coupled to said pair of E/O transmitter modules for feeding said egressing optical signal from said enabled E/O transmitter module to an optical signal destination.

2. The transponder according to claim 1 and further comprising a second O/E receiver module for converting a second optical signal to a second electrical signal, and a switching element for switching one of said electrical signals to said enabled E/O transmitter module.
